(19) United States
(12) Patent Application Publication
(10) Pub. No.: US 2014/0149984 A1
(43) Pub. Date: May 29, 2014

(54) INFORMATION PROCESSING APPARATUS, INFORMATION PROCESSING METHOD, AND COMPUTER READABLE MEDIUM

(71) Applicant: SONY CORPORATION, Tokyo (JP)

(72) Inventors: Ryo TAKAHASHI, Saitama (JP); Hiroki NAGAHAMA, Tokyo (JP); Yasuhiro MATSUZAKI, Tokyo (JP); Hiroaki ISHIZAWA, Chiba (JP)

(73) Assignee: SONY CORPORATION, Tokyo (JP)

(21) Appl. No.: 14/057,411

(22) Filed: Oct. 18, 2013

(30) Foreign Application Priority Data
Nov. 28, 2012 (JP) 2012-259574

(51) Int. Cl. G06F 9/50; G06F 9/48

(52) U.S. Cl. CPC G06F 9/5077; G06F 9/4856
USPC 718/1

(57) ABSTRACT

There is provided an information processing apparatus including circuitry configured to generate an instruction for running an application, and reserve a computer resource for running each of virtual machines corresponding to applications which are running instruction targets, in response to the generation of the running instruction.

### CROSS REFERENCE TO RELATED APPLICATIONS

This application claims the benefit of Japanese Priority Patent Application JP 2012-259574 filed Nov. 28, 2012, the entire contents of which are incorporated herein by reference.

### BACKGROUND

The present disclosure relates to an information processing apparatus, an information processing method, and a computer-readable medium.

There are applications having particular functions which are executed in a personal computer, a smartphone, a tablet terminal, a TV set, and other devices. Such applications are also referred to as “Apps”, and the applications of various types have been provided.

Meanwhile, there is a demand that an application used in a certain device should continuously be used in another device, and a technique to meet the demand is disclosed, for example, for a case where a game application executed in a smartphone is migrated to a tablet terminal, a TV set, or the like, to play the game on a larger display. As techniques making it possible to continuously use an application in another device as described above, there are process migration and the VM (Virtual Machine) migration.

These techniques are migration of an application by transferring the content of computer resources used by the application, to continuously use the application in another device. The process migration is capable of migrating an application alone to another device at high speed, but is not capable of migrating a hardware-dependent application. On the other hand, the VM migration is capable of migrating any application to another device, but it takes time to perform the migration. This is because a plurality of applications are operated on one VM, and thus an application independent of the target application is also migrated, so that a transfer amount is increased.

There have been disclosed technologies for speeding up the application transfer in the VM migration (JP 2010-231684A, JP 2009-116859A, and Post-Copy Based Live Virtual Machine Migration Using Adaptive Pre-Paging and Dynamic Self-Ballooning). Post-Copy Based Live Virtual Machine Migration Using Adaptive Pre-Paging and Dynamic Self-Ballooning discloses a technology by which a memory area not used by a VM is prevented from being transferred to reduce a memory transfer amount in VM migration. In JP 2010-231684A, a technology is disclosed by which when a VM arranged in a migration destination has the same memory page as a memory page of a VM to be migrated, transfer of the memory page is prevented. In JP 2009-116859A, a technology is disclosed by which a server manages computer resources such as a storage for a VM in an integrated manner, the computer resources are continuously utilized both before and after VM migration, and thereby a transfer amount in the VM migration is reduced.

### SUMMARY

Each of the aforementioned technologies is a technology for speeding up the VM migration, but remains migrating applications including even an application independent of a target application as mentioned above in the description of the VM migration. Thus, in light of such circumstances, there is room for improvement in speeding up the application migration.

In light of the foregoing, it is desirable to provide an information processing apparatus, an information processing method, and a non-transitory computer readable medium which are novel and improved and which can transfer applications at high speed in VM migration capable of migrating even a hardware-dependent application.

According to an embodiment of the present disclosure, there is provided an information processing apparatus including circuitry configured to generate an instruction for running an application, and reserve a computer resource for running each of virtual machines corresponding to applications which are running instruction targets, in response to the generation of the running instruction.

According to an embodiment of the present disclosure, there is provided an information processing method including generating an instruction for running an application, and in response to the generation of the running instruction in the instruction generation step, managing a virtual machine to reserve a computer resource for running the virtual machine corresponding to the application which is a running instruction target.

According to an embodiment of the present disclosure, there is provided a non-transitory computer readable medium having stored thereon a program that when executed by a computer causes the computer to execute generating an instruction for running an application, and in response to the generation of the running instruction in the instruction generation step, managing a virtual machine to reserve a computer resource for running the virtual machine corresponding to the application which is a running instruction target.

According to the embodiment of the present disclosure as described above, it is possible to provide an information processing apparatus, an information processing method, and a non-transitory computer readable medium which are novel and improved and which can transfer applications at high speed in VM migration capable of migrating even a hardware-dependent application.

### BRIEF DESCRIPTION OF THE DRAWINGS

FIG. 1 is an explanatory diagram illustrating a functional configuration example of an information processing apparatus according to an embodiment of the present disclosure;

FIG. 2 is an explanatory diagram illustrating a functional configuration example of an App VM 140 operated in an information processing apparatus 100 according to an embodiment of the present disclosure;

FIG. 3 is an explanatory diagram illustrating a functional configuration example of a main VM 130 operated in the information processing apparatus 100 according to an embodiment of the present disclosure;

FIG. 4 is an explanatory diagram illustrating a functional configuration example of a VM management unit 121 included in the information processing apparatus 100 according to an embodiment of the present disclosure;

FIG. 5 is a flowchart illustrating an operation of the information processing apparatus 100 according to an embodiment of the present disclosure;

FIG. 6 is a flowchart illustrating an operation of the information processing apparatus 100 according to an embodiment of the present disclosure;

FIG. 7 is a flowchart illustrating an operation of the information processing apparatus 100 according to an embodiment of the present disclosure;

FIG. 8 is a flowchart illustrating an operation of the information processing apparatus 100 according to an embodiment of the present disclosure;

FIG. 9 is an explanatory diagram illustrating a modification of the information processing apparatus 100 according to an embodiment of the present disclosure;

FIG. 10 is an explanatory diagram illustrating a modification of the information processing apparatus 100 according to an embodiment of the present disclosure; and

FIG. 11 is an explanatory diagram illustrating a hardware configuration example of the information processing apparatus.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the descriptions will be given in the following order.

<1. Embodiment of Present Disclosure>

[Functional Configuration Example of Information Processing Apparatus]

[Functional Configuration Example of App VM]

[Functional Configuration Example of Main VM]

[Functional Configuration Example of VM Management Unit]

[Operation Examples of Information Processing Apparatus]

[Modifications]

<2. Hardware Configuration Example>

<3 Summarization>

<1. Embodiment of Present Disclosure>

[Functional Configuration Example of Information Processing Apparatus]

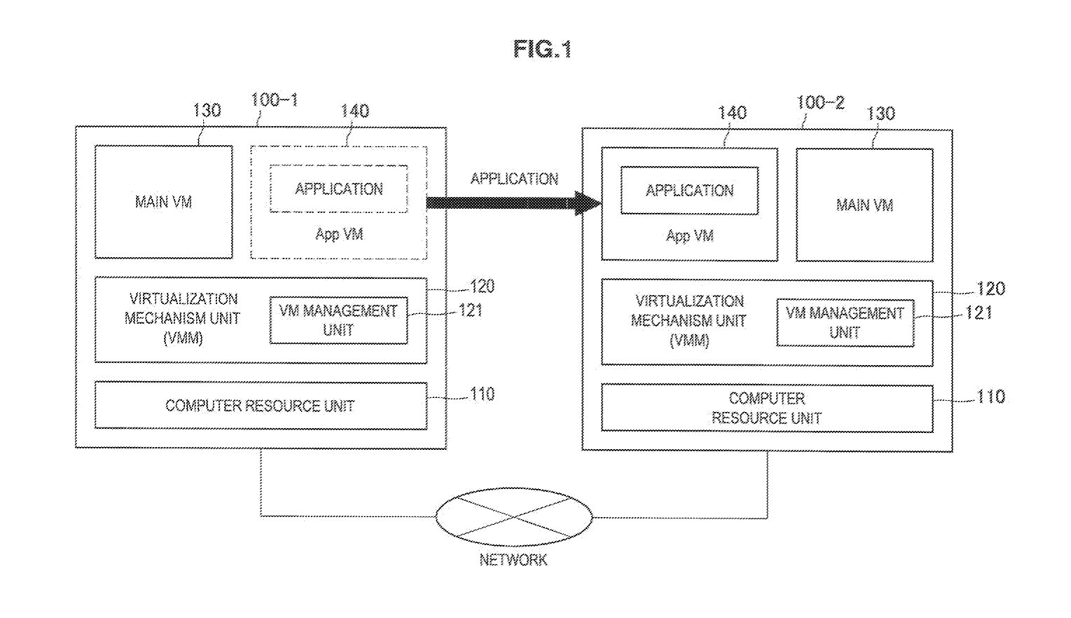

Firstly, a functional configuration example of an information processing apparatus according to an embodiment of the present disclosure will be described with reference to the drawings. FIG. 1 is an explanatory diagram illustrating a functional configuration example of the information processing apparatus according to the embodiment of the present disclosure. Hereinafter, the functional configuration example of the information processing apparatus according to the embodiment of the present disclosure will be described by using FIG. 1.

As illustrated in FIG. 1, an information processing apparatus 100-1 according to the embodiment of the present disclosure includes a computer resource unit 110 and a virtualization mechanism unit 120. The information processing apparatus 100-1 according to the embodiment of the present disclosure is an apparatus capable of migrating applications to another information processing apparatus 100-2 by using virtual machine (VM) migration. In an example of a conceivable mode, the information processing apparatus 100-1 is a tablet information processing apparatus, while the information processing apparatus 100-2 is a smartphone (high-functional mobile phone).

Here, when not particularly necessarily being discriminated from each other in the following description, the information processing apparatuses 100-1 and 100-2 are simply referred to as an information processing apparatus 100.

The computer resource unit 110 includes a memory, a CPU (Central Processing Unit), network resources, and the like which are used by virtual machines (VMs) run by a virtualization mechanism unit 120. The memory included in the computer resource unit 110 includes both a volatile memory and a non-volatile memory.

The virtualization mechanism unit 120 performs such control that starts virtual machines inside the information processing apparatus 100 and causes the virtual machines to run applications. As illustrated in FIG. 1, the virtualization mechanism unit 120 includes a VM management unit 121. The VM management unit 121 manages information on the starting of each virtual machine and on the corresponding application to be executed by the virtual machine. The VM management unit 121 may be provided in a mode of a software module, for example. The VM management unit 121 migrates the run virtual machines to the other information processing apparatus 100-2 by using the virtual machine (VM) migration, as appropriate in such a case that a user instructs for migration.

There are two types of the virtual machines operated by the virtualization mechanism unit 120 inside the information processing apparatus 100. The one type of the virtual machines are denoted with reference numeral 140 in FIG. 1 and are assigned to applications on an one-to-one basis. In the present embodiment, the virtual machines assigned to applications on the one-to-one basis are referred to as “App VMs”. The other type of the virtual machines are denoted with reference numeral 130 in FIG. 1 and are each configured to cause the user to select an application and transfer an execution file of the selected application, data to be used by the application, and the like to the corresponding App VM. In the present embodiment, such virtual machines are referred to as “main VMs”.

FIG. 1 illustrates the main VMs and the App VMs operating inside the information processing apparatus 100. Although FIG. 1 illustrates a state where one App VM operates inside the information processing apparatus 100-1, the App VMs are the virtual machines assigned to applications on the one-to-one basis as described above and exist for the respective applications in the information processing apparatus 100-1.

The App VMs can be transferred from the information processing apparatus 100-1 to the information processing apparatus 100-2 in accordance with an instruction by the user. The information processing apparatus 100 according to the embodiment of the present disclosure prepares the App VMs for the respective applications and transfers the applications to another apparatus in App VM units, thereby enabling high speed application transfer.

The functional configuration example of the information processing apparatus according to the embodiment of the present disclosure has heretofore been described by using FIG. 1. Next, a description is given of a functional configuration example of each App VM operated in the information processing apparatus 100 according to the embodiment of the present disclosure.

[Functional Configuration Example of App VM]

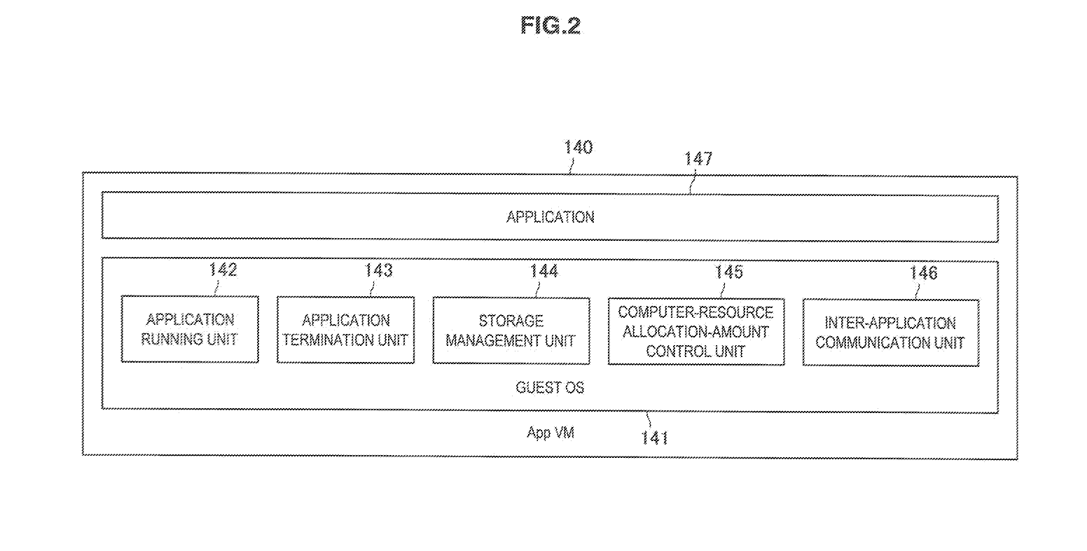

FIG. 2 is an explanatory diagram illustrating a functional configuration example of each App VM 140 operated in the information processing apparatus 100 according to the embodiment of the present disclosure. Hereinafter, by using FIG. 2, a description is given of the functional configuration example of the App VM 140 operated in the information processing apparatus 100 according to the embodiment of the present disclosure.

As illustrated in FIG. 2, the App VM 140 operated in the information processing apparatus 100 according to the embodiment of the present disclosure includes a guest OS 141 and an application 147. The guest OS 141 is an operating system for causing the App VM 140 to run the application 147.

As illustrated in FIG. 2, the guest OS 141 includes an application running unit 142, an application termination unit 143, a storage management unit 144, a computer-resource allocation-amount control unit 145, and an inter-application communication unit 146.

The application running unit 142 runs, on the App VM 140, an application designated as a running target by the user. When the user terminates the application running on the App VM 140, the application termination unit 143 notifies the VM management unit 121 that the application is terminated.

The storage management unit 144 manages reading and writing of data used by the application run by the application running unit 142 from and to a storage included in the computer resource unit 110 (a HDD, a non-volatile memory, or the like). Although specific processes will be described later, the storage management unit 144 receives an execution file for the application and the data to be used by the application from the main VM 130 at the time of running the application, and writes the received file and data to a part of the computer resource unit 110 to be used by the App VM 140. At the time of termination of the application, the storage management unit 144 reads the file and data written to the part of the computer resource unit 110 used by the App VM 140 and transmits the read data and files to the main VM 130. Even when an application executed in a certain App VM is executed on another App VM, the storage management unit 144 operates in such a manner and thereby can continuously use the data used by the application.

The computer-resource allocation-amount control unit 145 controls an allocation amount of the computer resource unit 110 used by the App VM 140. The VM management unit 121 of the virtualization mechanism unit 120 illustrated in FIG. 1 is not capable of detecting how much computer resource the application on the App VM 140 uses. Thus, the VM management unit 121 is not capable of allocating by itself a minimum necessary computer resource to the App VM 140. Hence, in the present embodiment, through the computer-resource allocation-amount control unit 145, the VM management unit 121 monitors an amount of a computer resource used by the application executed on the App VM 140. In other words, the computer-resource allocation-amount control unit 145 has a function of monitoring the amount of the computer resource used by the application executed on the App VM 140 and providing the VM management unit 121 with information on the use amount. The computer-resource allocation-amount control unit 145 may execute control of changing the amount of computer resource allocation to the App VM 140, based on a state of computer resource use by the App VM 140. For example, when the monitoring of the amount of computer resource use shows that the amount of computer resource use by the running App VM 140 has exceeded a predetermined threshold, the computer-resource allocation-amount control unit 145 may execute control of increasing the amount of computer resource allocation to the App VM 140. In addition, for example, when a tendency of an increase of the amount of computer resource use by the running App VM 140 can be predicted in monitoring the amount of computer resource use, the computer-resource allocation-amount control unit 145 may execute control of increasing the amount of computer resource allocation to the App VM 140.

The inter-application communication unit 146 performs communication between the App VMs 140 which are different from each other but run on the same information processing apparatus 100. When applications are executed on individual App VMs, it is not possible to perform inter-application communication in related art. This is because, even though the App VMs run on the same information processing apparatus 100, each guest OS thereof sees as if the App VM of the counterpart ran on a different apparatus (physical computer). Thus, it is necessary to support the communication between the applications executed on respective different App VMs 140 operating on the same information processing apparatus 100. The inter-application communication unit 146 supports the communication between the applications executed on the respective different App VMs 140. To enable the communication between the applications executed on the different App VMs 140 operating on the same information processing apparatus 100, the inter-application communication unit 146 plays a role of intervening in the communication between the applications. An inter-application communication process using the inter-application communication unit 146 will be described later in detail.

The functional configuration example of the App VM 140 operated in the information processing apparatus 100 according to the embodiment of the present disclosure has heretofore been described by using FIG. 2. Next, a description is given of a functional configuration example of the main VM 130 operated in the information processing apparatus 100 according to the embodiment of the present disclosure.

[Functional Configuration Example of Main VM]

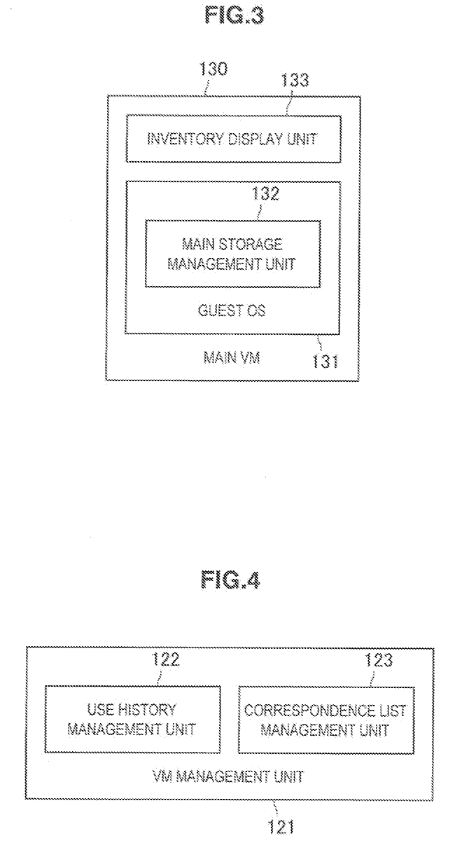

FIG. 3 is an explanatory diagram illustrating the functional configuration example of the main VM 130 operated in the information processing apparatus 100 according to the embodiment of the present disclosure. Hereinafter, a functional configuration example of the main VM 130 operated in the information processing apparatus 100 according to the embodiment of the present disclosure will be described by using FIG. 3.

As illustrated in FIG. 3, the main VM 130 operated in the information processing apparatus 100 according to the embodiment of the present disclosure includes a guest OS 131 and an inventory display unit 133. The guest OS 131 is an operating system for executing various processes on the main VM 130. As processes executed by the main VM 130, the following processes are shown herein: a process of causing the user to select an application; and a process of transferring an execution file of the selected application and data to be used by the application, to the corresponding App VM 140 on which the application is executed. It goes without saying that the processes executed by the main VM 130 are not limited to these.

The inventory display unit 133 displays an inventory of applications which can be provided by the information processing apparatus 100 to the user, on a screen (not shown) of the information processing apparatus 100. The inventory display unit 133 can display the inventory of the applications on the screen in various formats. For example, the inventory display unit 133 may display the inventory of the applications on the screen in a list format or in such a format as to arrange icons. The inventory display unit 133 generates an instruction for running the application selected by the user and transmits the generated running instruction to the VM management unit 121. Thus, the inventory display unit 133 has a function exemplified as an instruction generation unit according to the embodiment of the present disclosure.

As illustrated in FIG. 3, the guest OS 131 of the main VM 130 includes a main storage management unit 132. The main storage management unit 132 executes processes of: reading an execution file of an application and data to be used by the application from the computer resource unit 110, the application being displayed on the screen (not shown) of the information processing apparatus 100 by the inventory display unit 133 and being selected by the user; and transferring the execution file and the data to the App VM 140 on which the application is executed. The main storage management unit 132 also executes a process of retrieving data having been transferred to the App VM 140, when the App VM 140 is terminated.

The functional configuration example of the main VM 130 operated in the information processing apparatus 100 according to the embodiment of the present disclosure has heretofore been described by using FIG. 3. Next, a description is given of a functional configuration example of the VM management unit 121 included in the information processing apparatus 100 according to the embodiment of the present disclosure.

[Functional Configuration Example of VM Management Unit]

FIG. 4 is an explanatory diagram illustrating the functional configuration example of the VM management unit 121 included in the information processing apparatus 100 according to the embodiment of the present disclosure. By using FIG. 4, a description is given below of the functional configuration example of the VM management unit 121 included in the information processing apparatus 100 according to the embodiment of the present disclosure.

As illustrated in FIG. 4, the VM management unit 121 includes a use history management unit 122 and a correspondence list management unit 123.

The use history management unit 122 manages a use history of the computer resource in the computer resource unit 110 used by each application executed on the corresponding App VM 140. The use history of the computer resource managed by the use history management unit 122 is used to determine an amount of the computer resource to be allocated to the App VM 140 at the start of the App VM 140 or during the running of the App VM 140.

The correspondence list management unit 123 manages a list of correspondence between App VMs and applications. That is, the correspondence list management unit 123 manages a correspondence list showing which App VM executes which application. The correspondence list managed by the correspondence list management unit 123 is used for the inter-application communication process by the inter-application communication unit 146.

The functional configuration example of the VM management unit 121 included in the information processing apparatus 100 according to the embodiment of the present disclosure has heretofore been described by using FIG. 4. Next, a description is given of operation examples of the information processing apparatus 100 according to the embodiment of the present disclosure.

[Operation Examples of Information Processing Apparatus]

As the operation examples of the information processing apparatus 100 according to the embodiment of the present disclosure, the following processes are described: an application running process; an application termination process; a process of controlling an amount of computer resource allocation to an App VM; and the inter-application communication process.

(1) Application Running Process

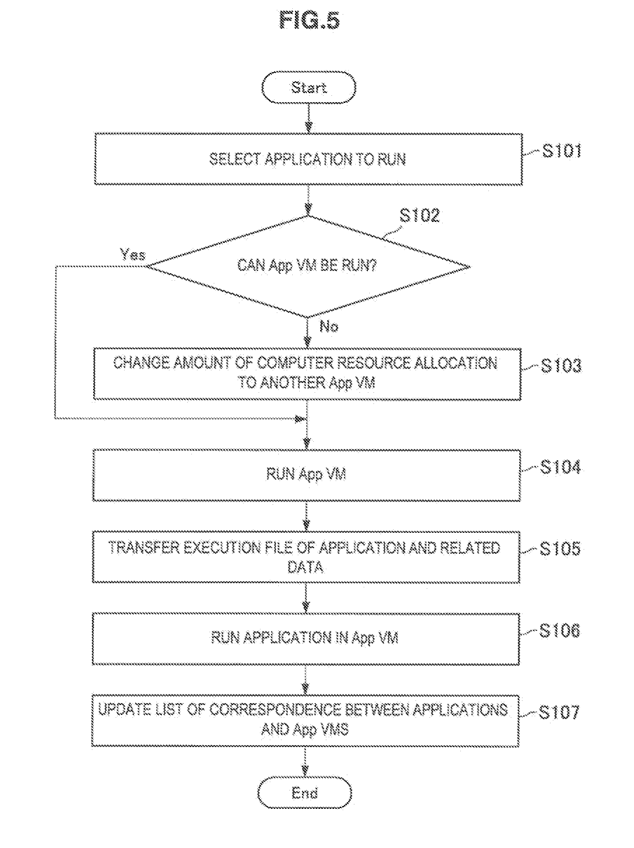

FIG. 5 is a flowchart illustrating an operation of the information processing apparatus 100 according to the embodiment of the present disclosure. The operation illustrated in FIG. 5 is how the information processing apparatus 100 operates when one of the App VMs 140 is reserved inside the information processing apparatus 100 to run an application on the App VM 140. Hereinafter, a description is given of the operation of the information processing apparatus 100 according to the embodiment of the present disclosure by using FIG. 5.

When the user selects an application to be run from the applications displayed on the screen of the information processing apparatus 100 by the inventory display unit 133 of the main VM 130 (Step S101), the inventory display unit 133 notifies the VM management unit 121 of the selected application.

Upon receipt of the notification of the selected application from the inventory display unit 133, the VM management unit 121 determines an amount of computer resource allocation to the App VM 140 for the selected application, based on the use history of the computer resource in the computer resource unit 110 managed by the use history management unit 122, and judges the feasibility of running of the App VM 140 (Step S102). The VM management unit 121 judges the feasibility of the running of the App VM 140 based on the feasibility of reserving of the computer resource in the computer resource unit 110 to be used by the selected application.

If it is judged in Step S102 above that the running of the App VM 140 for the application selected in Step S101 is feasible, the VM management unit 121 runs the App VM 140 for the selected application by using a virtual machine snapshot technology (Step S104). Note that the VM management unit 121 may use not only the virtual machine snapshot technology but also recover a virtual machine in a halt state, if the virtual machine exists. The virtual machine in the halt state means a virtual machine in a state where the virtual machine is loaded into the memory but has not been executed yet.

On the other hand, it is judged in Step S102 above that the running of the App VM 140 for the application selected in Step S101 is not feasible for such a reason that another one of the App VMs 140 which has already been run uses the computer resource, the VM management unit 121 changes an amount of allocation of the computer resource in the computer resource unit 110 to the already run App VM 140 (Step S103). When the running of the App VM 140 for the application selected in Step S101 becomes feasible as a result of changing in Step S103 of the amount of allocation of the computer resource in the computer resource unit 110 to the already run App VM 140, the VM management unit 121 runs the App VM 140 for the selected application by using the virtual machine snapshot technology (Step S104).

Note that if the running of the App VM 140 for the application selected in Step S101 is still infeasible in spite of the changing in Step S103 of the amount of allocation of the computer resource in the computer resource unit 110 to the already run App VM 140, the VM management unit 121 may display, on the screen of the information processing apparatus 100, such a message that indicates termination of the application executed by the already run App VM 140.

After running the App VM 140 in Step S104 above, the VM management unit 121 subsequently transfers an execution file of the application selected in Step S101 and data to be used by the application from the main VM 130 to the App VM 140, by causing the main storage management unit 132 of the main VM 130 and the storage management unit 144 of the App VM 140 to cooperate with each other (Step S105).

After transferring the execution file of the application selected in Step S101 and the data to be used by the application from the main VM 130 to the App VM 140 in Step S105 above, the VM management unit 121 notifies the application running unit 142 of the App VM 140 run in Step S104 of the application selected in Step S101. Upon receipt of the notification of the application selected in Step S101 from the VM management unit 121, the application running unit 142 runs the application selected in Step S101 by using the execution file transferred in Step S105 above (Step S106).

When, in Step S106 above, the application running unit 142 runs the application selected in Step S101, the VM management unit 121 updates the list of correspondence between applications and App VMs managed by the correspondence list management unit 123 (Step S107).

The information processing apparatus 100 according to the embodiment of the present disclosure executes the operation as illustrated in FIG. 5, and thereby can operate the App VMs 140 in application units. In addition, each App VM 140 executing the corresponding application 147 is transferred to another information processing apparatus (for example, the information processing apparatus 100-2 illustrated in FIG. 1), and thereby the information processing apparatus 100 according to the embodiment of the present disclosure (for example, the information processing apparatus 100-1 illustrated in FIG. 1) can transfer an application at high speed in the VM migration capable of migrating even a hardware-dependent application.

How the information processing apparatus 100 operates when the App VM 140 is reserved inside the information processing apparatus 100 to run an application on the App VM 140 has heretofore been described by using FIG. 5.

(2) Application Termination Process

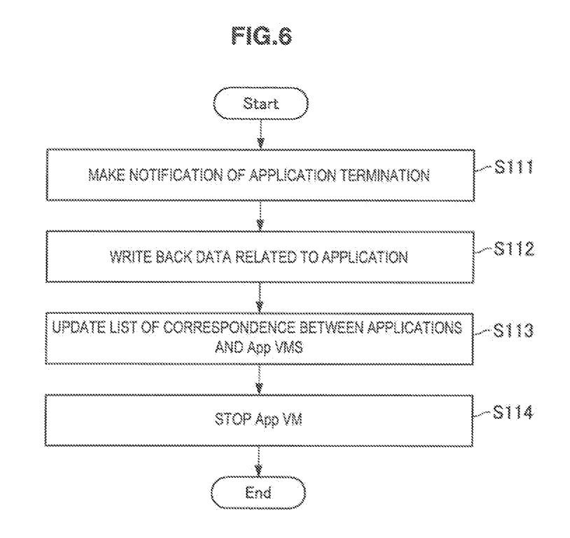

FIG. 6 is a flowchart illustrating an operation of the information processing apparatus 100 according to the embodiment of the present disclosure. The operation illustrated in FIG. 6 is an operation of terminating an application executed on the App VM 140. Hereinafter, a description is given of the operation of the information processing apparatus 100 according to the embodiment of the present disclosure by using FIG. 6.

When the user terminates the application executed on the App VM 140 and when the application termination unit 143 of the App VM 140 detects the termination of the application, the application termination unit 143 notifies the VM management unit 121 of the termination of the application (Step S111).

The VM management unit 121 having received the notification of the application termination from the application termination unit 143 writes data used by the application back to the main VM 130 (Step S112). Specifically, the VM management unit 121 acquires data used by the application from the storage management unit 144 of the App VM 140 executing the application and delivers the data to the main storage management unit 132 of the main VM 130, thereby writing the data used by the application back to the main VM 130.

After the VM management unit 121 writes the data back to the main VM 130 in Step S112 above, the VM management unit 121 subsequently updates the list of correspondence between applications and App VMs managed by the correspondence list management unit 123 (Step S113). The VM management unit 121 herein updates the correspondence list managed by the correspondence list management unit 123, for example, in such a manner as to erase a correspondence between the terminated application and the corresponding App VM from the correspondence list.

After updating the correspondence list in Step S113 above, the VM management unit 121 stops the App VM 140 executing the terminated application (Step S114).

Note that the VM management unit 121 stops the App VM 140 executing the terminated application in Step S114 above, but the embodiment of the present disclosure is not limited to the example. For example, instead of the stopping, the VM management unit 121 may bring the App VM 140 executing the terminated application into a halt state, that is, in a state where the App VM 140 is ready for reuse for another application.

How the information processing apparatus 100 operates when the application executed on the App VM 140 is terminated has heretofore been described by using FIG. 6.

(3) Resource-Allocation-Amount Change Process

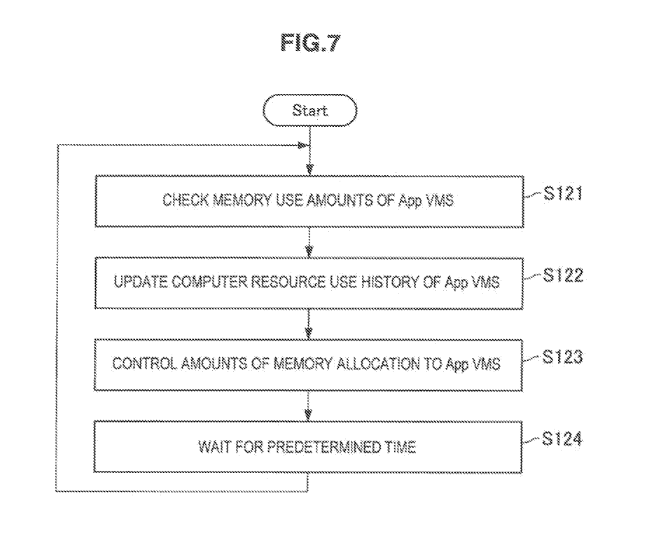

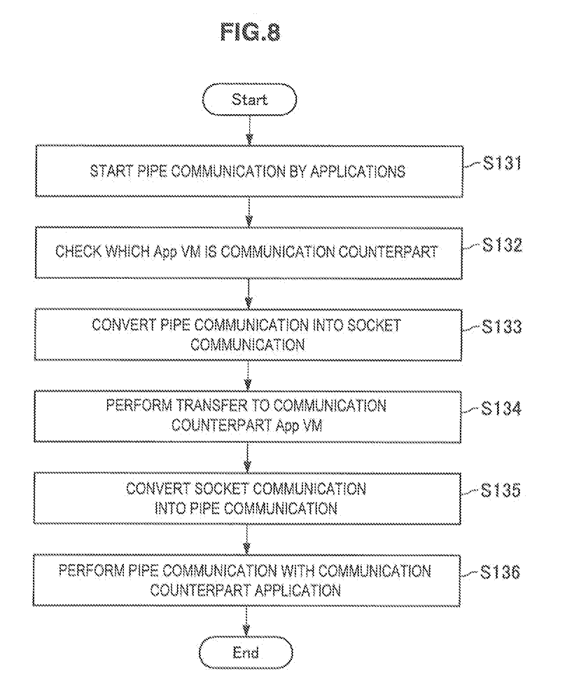

FIG. 7 is a flowchart illustrating an operation of the information processing apparatus 100 according to the embodiment of the present disclosure. The operation illustrated in FIG. 7 is an operation performed in controlling amounts of allocation of a computer resource in the computer resource unit 110 to the App VMs 140. Hereinafter, a description is given of the operation of the information processing apparatus 100 according to the embodiment of the present disclosure by using FIG. 7. The description is given here by taking a memory as an example of the computer resource in the computer resource unit 110.

The VM management unit 121 regularly acquires memory use amounts used by applications executed by the App VMs 140, through the computer-resource allocation-amount control unit 145 included in the guest OS 141 of the App VM 140, by checking the memory use amounts used by the applications executed by the App VMs 140 (Step S121).

After acquiring the memory use amounts used by the applications executed by the App VMs 140 in Step S121 above, the VM management unit 121 causes the use history management unit 122 to manage values acquired in Step S121 above (Step S122).

Then, the VM management unit 121 determines and controls the amounts of computer resource allocation to the App VMs 140 for the applications, based on the use history of the computer resource of the computer resource unit 110 managed by the use history management unit 122 (Step S123).

After determining and controlling the amounts of computer resource allocation to the App VMs 140 in Step S123 above, the VM management unit 121 waits for a predetermined time (Step S124) and thereafter moves back to Step S121 above.

Note that the VM management unit 121 regularly executes the resource-allocation-amount change process in FIG. 7, but the embodiment of the present disclosure is not limited to the example. For example, the VM management unit 121 may be configured to execute the resource-allocation-amount change process when the entire system executed by the information processing apparatus 100 is in such a computer resource shortage state that a remaining computer resource falls below a predetermined threshold, or when any of the App VMs 140 is in a computer resource shortage state. The VM management unit 121 may be configured to combine and execute the regularly performed resource-allocation-amount change process and a resource-allocation-amount change process to be performed depending on a computer resource use state, as a manner of course.

By using FIG. 7, the description has heretofore been given of how the information processing apparatus 100 according to the embodiment of the present disclosure operates in controlling the allocation amounts of the computer resource in the computer resource unit 110 to the App VMs 140.

(4) Inter-Application Communication Process

FIG. 8 is a flowchart illustrating an operation of the information processing apparatus 100 according to the embodiment of the present disclosure. The operation illustrated in FIG. 8 is an operation performed when communication is performed between different applications executed on the respective App VMs 140 operating on the same information processing apparatus 100. By using FIG. 8, a description is given below of the operation of the information processing apparatus 100 according to the embodiment of the present disclosure.

To enable the communication between the applications executed on the App VMs 140, the inter-application communication unit 146 included in the guest OS 141 of each App VM 140 in the information processing apparatus 100 according to the embodiment of the present disclosure intervenes in the inter-application communication. In the description in the present embodiment, pipe communication is taken as an example of the inter-application communication. The inter-application communication unit 146 intervenes in the inter-application communication to thereby enable communication equivalent to that in the case of executing applications on the same OS.

Firstly, one of the applications 147 executed on the corresponding App VM 140 starts pipe communication with another application 147 executed on the corresponding App VM 140 (Step S131).

After the application 147 starts the pipe communication with the other application 147 in Step S131 above, the inter-application communication unit 146 of the communication source inquiries of the VM management unit 121 about which one of the App VMs 140 operates the communication-destination application 147 with which the communication-source application 147 attempts communication (Step S132).

The VM management unit 121 refers to the list of correspondence between applications and App VMs managed by the correspondence list management unit 123, and returns information on the App VM 140 executing the communication-destination application 147 to the communication-source inter-application communication unit 146 (Step S132).

The communication-source inter-application communication unit 146 having received the information on the App VM 140 executing the communication-destination application 147 from the VM management unit 121 converts a format of the pipe communication started by the communication-source application 147 in Step S131 above into that of socket communication (Step S133).

Then, the communication-source inter-application communication unit 146 transfers the content of the socket communication converted in Step S133 above, to the App VM 140 executing the communication-destination application 147, the App VM 140 being acquired from the VM management unit 121 in Step S132 above (Step S134).

When the communication-destination App VM 140 executing the communication-destination application 147 receives the transfer from the communication-source inter-application communication unit 146, the inter-application communication unit 146 of the communication-destination App VM 140 converts the format of the socket communication into that of the pipe communication (Step S135).

After converting the format of the socket communication into that of the pipe communication in Step S135 above, the inter-application communication unit 146 of the communication-destination App VM 140 transfers the converted content to the application 147 executed by the communication-destination App VM 140 (Step S136).

The information processing apparatus 100 according to the embodiment of the present disclosure executes a series of steps as illustrated in FIG. 8 to thereby enable the communication between the different applications 147 executed on the respective App VMs 140.

[Modifications]

Subsequently, a description is given of modifications of the information processing apparatus 100 according to the embodiment of the present disclosure. The description has been given above of the configuration in which the main VM 130 includes the main storage management unit 132 and the inventory display unit 133, but the embodiment of the present disclosure is not limited to the example.

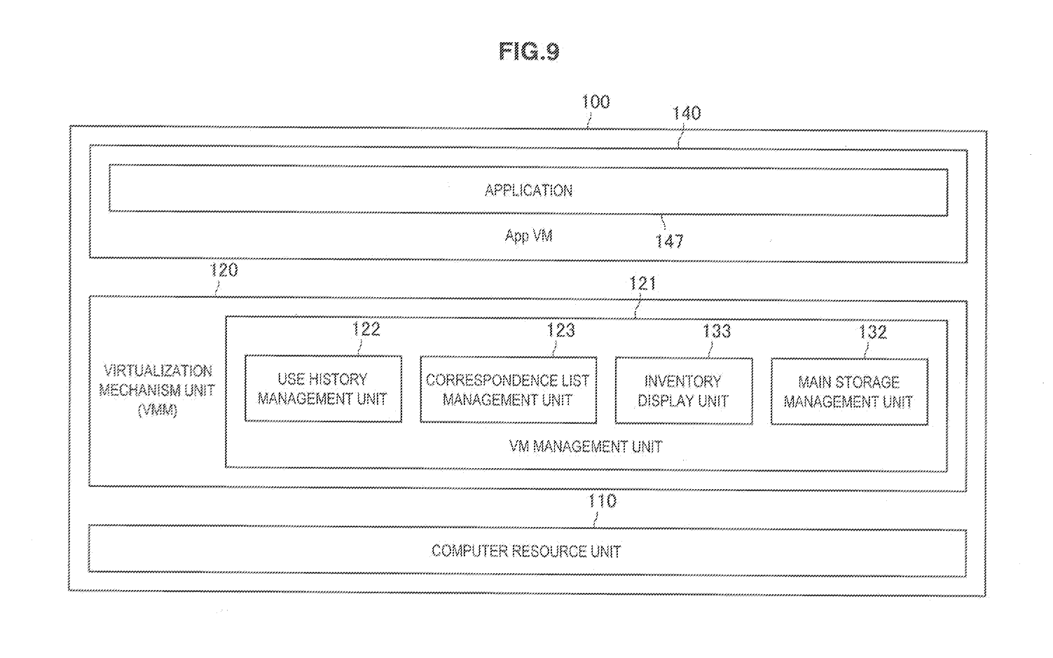

FIG. 9 is an explanatory diagram illustrating one of the modifications of the information processing apparatus 100 according to the embodiment of the present disclosure. The modification in FIG. 9 illustrates a case where the VM management unit 121 includes the main storage management unit 132 and the inventory display unit 133. As described above, the VM management unit 121 may include the main storage management unit 132 and the inventory display unit 133.

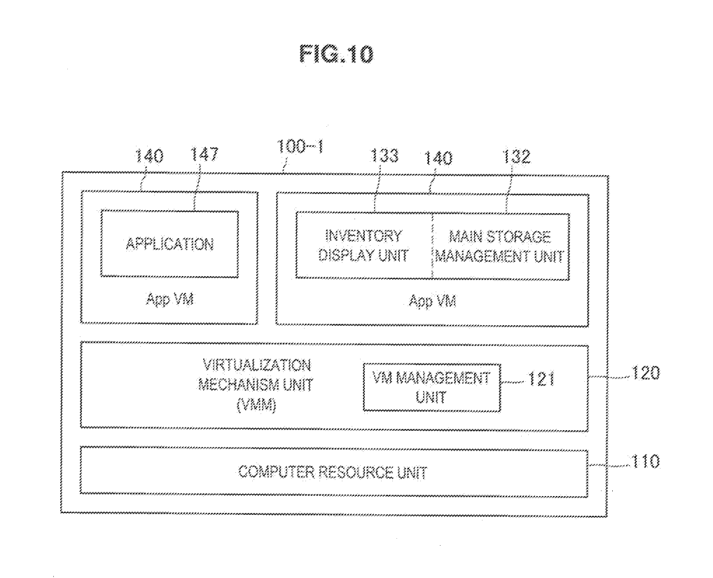

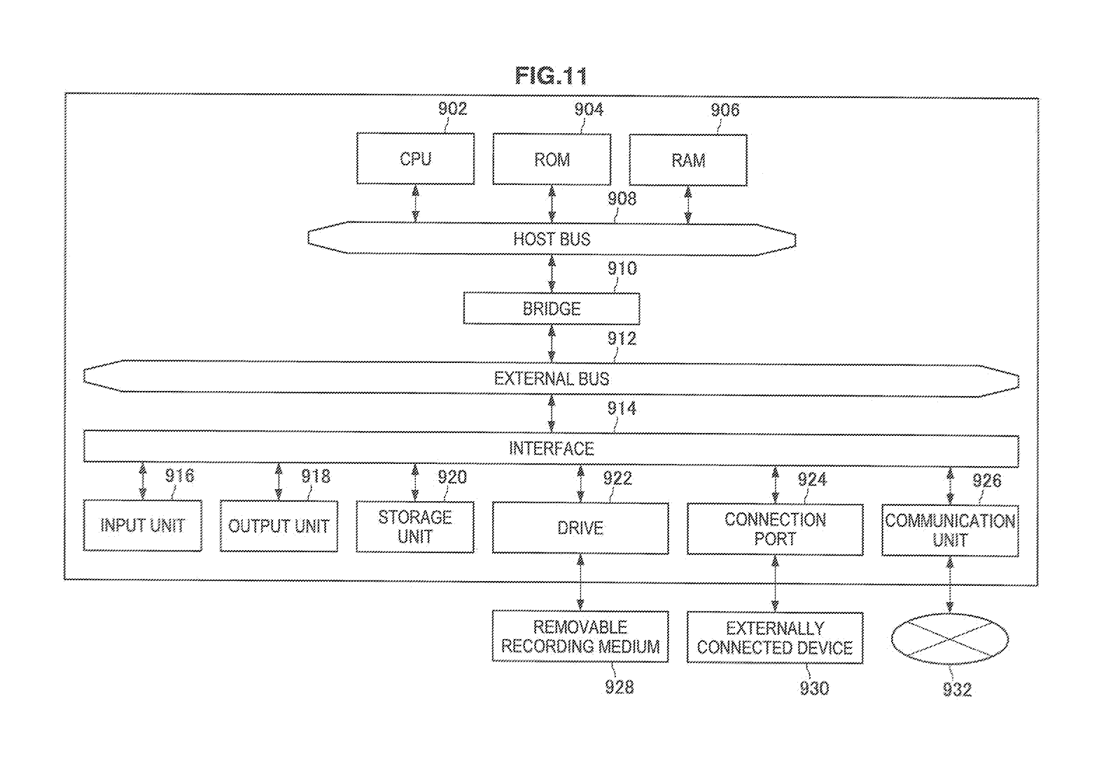

Moreover, the functions of the main storage management unit 132 and the inventory display unit 133 may be implemented as applications. FIG. 10 is an explanatory diagram illustrating the other one of the modifications of the information processing apparatus 100 according to the embodiment of the present disclosure. The modification in FIG. 10 illustrates a case where the main storage management unit 132 and the inventory display unit 133 are operated on the App VM 140. As described above, unlike the configuration in FIG. 1 in which the main VM 130 and the App VM 140 are separated from each other, the information processing apparatus 100 according to the embodiment of the present disclosure may have the configuration in FIG. 10 by implementing the functions of the main storage management unit 132 and the inventory display unit 133 as the applications.

<2. Hardware Configuration Example>

The algorithm described above can be executed by using, for example, a hardware configuration of an information processing apparatus illustrated in FIG. 11. In other words, the processes in the algorithm are implemented by controlling hardware illustrated in FIG. 11 by using a computer program. Note that the hardware may be in any mode, and includes, for example: mobile information terminals such as a personal computer, a mobile phone, a PHS, and a PDA; a game machine; a contact IC chip and a non-contact IC chip; and various personal digital electronics. Note that PHS described above stands for Personal Handy-phone System; and PDA, Personal Digital Assistant.

As illustrated in FIG. 11, the hardware mainly includes a CPU 902, a ROM 904, a RAM 906, a host bus 908, and a bridge 910. The hardware further includes an external bus 912, an interface 914, an input unit 916, an output unit 918, a storage unit 920, a drive 922, a connection port 924, and a communication unit 926. Note that CPU described above stands for Central Processing Unit; ROM, Read Only Memory; and RAM, Random Access Memory.

The CPU 902 functions as, for example, an arithmetic processing unit or a control device, and controls the entirety or part of operation of the components, based on various programs recorded in the ROM 904, the RAM 906, the storage unit 920, or a removable recording medium 928. The ROM 904 is a device configured to store programs to be read by the CPU 902, data used for computation, and the like. The RAM 906 temporarily or permanently stores the programs to be read by the CPU 902, various parameters appropriately varying in executing the programs, and the like.

These components are mutually connected, for example, through the host bus 908 capable of high speed data transmission. The host bus 908 is connected to the external bus 912 having a relatively low data transmission speed, for example, through the bridge 910. As the input unit 916, a mouse, a keyboard, a touch panel, a button, a switch, a handle, or the like is used. As the input unit 916, a remote controller is sometimes used which is capable of transmitting a control signal by using infrared rays or other electronic waves.

The output unit 918 is a device capable of visually or audibly notifying the user of acquired information, including: display devices such as a CRT, a LCD, a PDP, and an ELD; audio output devices such as a speaker and a headphone; a printer; a mobile phone; a fax machine; and the like. Note that CRT described above stands for Cathode Ray Tube; LCD, Liquid Crystal Display; PDP, Plasma Display Panel; and ELD, Electro-Luminescence Display.

The storage unit 920 is a device for storing various data pieces. As the storage unit 920, a magnetic storage device is used, such as a HDD, a semiconductor storage device, an optical storage device, a magneto-optical storage device, or the like. Note that HDD described above stands for Hard Disk Drive.

The drive 922 is a device configured to read information recorded in the removable recording medium 928 such as a magnetic disk, an optical disk, a magneto-optical disk, or a semiconductor memory, or configured to write information to the removable recording medium 928. The removable recording medium 928 is a DVD medium, a Blu-ray medium, a HD DVD medium, any of various semiconductor storage media, or the like. As a matter of course, the removable recording medium 928 may be an IC card with a non-contact IC chip mounted thereon, an electronic device, or the like. Note that IC described above stands for Integrated Circuit.

The connection port 924 is a port for connecting an externally connected device 930, such as a USB port, an IEEE1394 port, a SCSI, an RS-232C port, or an optical audio terminal. The externally connected device 930 is a printer, a mobile music player, a digital camera, a digital video camera, an IC recorder, or the like. Note that USB described above stands for Universal Serial Bus; and SCSI, Small Computer System Interface.

The communication unit 926 is a communication device for connecting to a network 932, such as a communication card for a wired or wireless LAN, Bluetooth (registered trademark), or WUSB, a router for optical communication, a router for ADSL, or a device for contact or non-contact communication. The network 932 connected to the communication unit 926 is configured of a network connected in a wired or wireless manner, and is the Internet, a home wireless LAN, infrared-ray communication, visible light communication, broadcasting, satellite communication, or the like. Note that LAN described above stands for Local Area Network; WUSB, Wireless USB; and ADSL, Asymmetric Digital Subscriber Line.

<3 Summarization>

According to the embodiment of the present disclosure as described above, App VMs are prepared for respective applications and the applications are transferred to another apparatus in App VM units, and thereby it is possible to provide the information processing apparatus 100 capable of transferring the applications to the other apparatus at high speed.

Steps of each process executed by each apparatus in the specification do not necessarily have to be performed in time-series in the order of the steps described in a sequence diagram or the flowchart. For example, the steps of the process executed by the apparatus may be performed in the order different from that described in the flowchart or may be performed in parallel.

It is also possible to generate a computer program for causing the hardware such as the CPU, the ROM, and the RAM which are built in each apparatus to exert functions equivalent to those in the aforementioned configuration of the apparatus. It is also possible to provide a storage medium storing the computer program. It is also possible to implement the series of processes by hardware, by configuring each functional block illustrated in the functional block diagram by hardware.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

an instruction generation unit configured to generate an instruction for running an application; and

a virtual machine management unit configured to reserve a computer resource for running each of virtual machines corresponding to applications which are running instruction targets, in response to the generation of the running instruction by the instruction generation unit.

(2) The information processing apparatus according to (1),

wherein the virtual machine management unit runs the virtual machine by using the reserved computer resource and thereafter runs the corresponding application which is the running instruction target on the virtual machine, and

wherein the information processing apparatus further includes a data management unit configured to provide the application run on the virtual machine by the virtual machine management unit with data to be used by the application.

(3) The information processing apparatus according to (1) or (2), further including

a computer-resource allocation-amount control unit configured to change an amount of allocation of the computer resource to the virtual machine.

(4) The information processing apparatus according to (3),

wherein when it is not possible for the virtual machine management unit to reserve the computer resource enabling the virtual machine to run, the computer-resource allocation-amount control unit changes an amount of allocation of the computer resource to another one of the virtual machines.

(5) The information processing apparatus according to (3),

wherein the computer-resource allocation-amount control unit changes the amount of allocation of the computer resource to the run virtual machine, based on a state of computer resource use by the virtual machine.

(6) The information processing apparatus according to (2),

wherein when execution of the application run on the virtual machine is terminated, the virtual machine management unit retrieves the data used by the application.

(7) The information processing apparatus according to (6),

wherein the data management unit acquires the data retrieved by the virtual machine management unit.

(8) The information processing apparatus according to any one of (2) to (7),

wherein when the execution of the application run on the virtual machine is terminated, the virtual machine management unit stops the virtual machine.

(9) The information processing apparatus according to any one of (2) to (8),

wherein when the execution of the application run on the virtual machine is terminated, the virtual machine management unit reuses the virtual machine for another one of the applications.

(10) The information processing apparatus according to any one of (2) to (9),

wherein the virtual machine management unit includes a correspondence list management unit configured to manage a list describing correspondence relationship of the applications run on the virtual machines.

(11) The information processing apparatus according to (10),

wherein the virtual machine management unit intervenes in communication between the applications run on the virtual machines, by using the list managed by the correspondence list management unit.

(12) The information processing apparatus according to any one of (2) to (11),

wherein the virtual machine management unit includes a use history management unit configured to manage a use history of the computer resource of the run virtual machine.

(13) The information processing apparatus according to (12),

wherein the virtual machine management unit determines an amount of allocation of the computer resource to the virtual machine, based on the use history managed by the use history management unit.

(14) The information processing apparatus according to (12),

wherein the virtual machine management unit determines an amount of allocation of the computer resource to the virtual machine being run, based on the use history managed by the use history management unit.

(15) The information processing apparatus according to any one of (2) to (14),

wherein the virtual machine management unit migrates the run virtual machine to another apparatus.

(16) An information processing method including:

generating an instruction for running an application; and

in response to the generation of the running instruction in the instruction generation step, managing a virtual machine to reserve a computer resource for running the virtual machine corresponding to the application which is a running instruction target.

(17) A computer program causing a computer to execute:

generating an instruction for running an application; and

in response to the generation of the running instruction in the instruction generation step, managing a virtual machine to reserve a computer resource for running the virtual machine corresponding to the application which is a running instruction target.

(18) An information processing apparatus including:

circuitry configured to
generate an instruction for running an application; and
reserve a computer resource for running each of virtual machines corresponding to applications which are running instruction targets, in response to the generation of the running instruction.
   (19) The information processing apparatus according to (18),

wherein the circuitry runs the virtual machine by using the reserved computer resource and thereafter runs the corresponding application which is the running instruction target on the virtual machine, and

wherein the circuitry is further configured to provide the application run on the virtual machine with data to be used by the application.

(20) The information processing apparatus according to (18) or (19), the circuitry is further configured to change an amount of allocation of the computer resource to the virtual machine.
(21) The information processing apparatus according to (20),

wherein when it is not possible to reserve the computer resource enabling the virtual machine to run, the circuitry changes an amount of allocation of the computer resource to another one of the virtual machines.

(22) The information processing apparatus according to (20),

wherein the circuitry changes the amount of allocation of the computer resource to the run virtual machine, based on a state of computer resource use by the virtual machine.

(23) The information processing apparatus according to (19),

wherein when execution of the application run on the virtual machine is terminated, the circuitry retrieves the data used by the application.

(24) The information processing apparatus according to (23),

wherein the circuitry acquires the data retrieved by the virtual machine management unit.

(25) The information processing apparatus according to (19) to (24),

wherein when the execution of the application run on the virtual machine is terminated, the circuitry stops the virtual machine.

(26) The information processing apparatus according to (19) to (25),

wherein when the execution of the application run on the virtual machine is terminated, the circuitry reuses the virtual machine for another one of the applications.

(27) The information processing apparatus according to (19) to (26),

wherein the circuitry is further configured to manage a list describing correspondence relationship of the applications run on the virtual machines.

(28) The information processing apparatus according to (27),

wherein the circuitry intervenes in communication between the applications run on the virtual machines, by using the list.

(29) The information processing apparatus according to (19) to (28),

wherein the circuitry is further configured to manage a use history of the computer resource of the run virtual machine.

(30) The information processing apparatus according to (29),

wherein when running the virtual machine, the circuitry determines an amount of allocation of the computer resource to the virtual machine, based on the use history.

(31) The information processing apparatus according to (29),

wherein the circuitry determines an amount of allocation of the computer resource to the virtual machine being run, based on the use history.

(32) The information processing apparatus according to (29),

wherein the circuitry migrates the run virtual machine to another apparatus.

(33) An information processing method including:

generating an instruction for running an application; and

in response to the generation of the running instruction in the instruction generation step, managing a virtual machine to reserve a computer resource for running the virtual machine corresponding to the application which is a running instruction target.

(34) A non-transitory computer readable medium having stored thereon a program that when executed by a computer causes the computer to execute:

generating an instruction for running an application; and

in response to the generation of the running instruction in the instruction generation step, managing a virtual machine to reserve a computer resource for running the virtual machine corresponding to the application which is a running instruction target.

What is claimed is:

1. An information processing apparatus comprising:
circuitry configured to
generate an instruction for running an application; and
reserve a computer resource for running each of virtual machines corresponding to applications which are running instruction targets, in response to the generation of the running instruction.

2. The information processing apparatus according to claim 1,
wherein the circuitry runs the virtual machine by using the reserved computer resource and thereafter runs the corresponding application which is the running instruction target on the virtual machine, and
wherein the circuitry is further configured to provide the application run on the virtual machine with data to be used by the application.

3. The information processing apparatus according to claim 1, the circuitry is further configured to change an amount of allocation of the computer resource to the virtual machine.

4. The information processing apparatus according to claim 3,
wherein when it is not possible to reserve the computer resource enabling the virtual machine to run, the circuitry changes an amount of allocation of the computer resource to another one of the virtual machines.

5. The information processing apparatus according to claim 3,
wherein the circuitry changes the amount of allocation of the computer resource to the run virtual machine, based on a state of computer resource use by the virtual machine.

6. The information processing apparatus according to claim 2,
wherein when execution of the application run on the virtual machine is terminated, the circuitry retrieves the data used by the application.

7. The information processing apparatus according to claim 6,
wherein the circuitry acquires the data retrieved by the virtual machine management unit.

8. The information processing apparatus according to claim 2,
wherein when the execution of the application run on the virtual machine is terminated, the circuitry stops the virtual machine.

9. The information processing apparatus according to claim 2,
wherein when the execution of the application run on the virtual machine is terminated, the circuitry reuses the virtual machine for another one of the applications.

10. The information processing apparatus according to claim 2,
wherein the circuitry is further configured to manage a list describing correspondence relationship of the applications run on the virtual machines.

11. The information processing apparatus according to claim 10,
wherein the circuitry intervenes in communication between the applications run on the virtual machines, by using the list.

12. The information processing apparatus according to claim 2,
wherein the circuitry is further configured to manage a use history of the computer resource of the run virtual machine.

13. The information processing apparatus according to claim 12,
wherein when running the virtual machine, the circuitry determines an amount of allocation of the computer resource to the virtual machine, based on the use history.

14. The information processing apparatus according to claim 12,
wherein the circuitry determines an amount of allocation of the computer resource to the virtual machine being run, based on the use history.

15. The information processing apparatus according to claim 2,
wherein the circuitry migrates the run virtual machine to another apparatus.

16. An information processing method comprising:
generating an instruction for running an application; and
in response to the generation of the running instruction in the instruction generation step, managing a virtual machine to reserve a computer resource for running the virtual machine corresponding to the application which is a running instruction target.

17. A non-transitory computer readable medium having stored thereon a program that when executed by a computer causes the computer to execute:
generating an instruction for running an application; and
in response to the generation of the running instruction in the instruction generation step, managing a virtual machine to reserve a computer resource for running the virtual machine corresponding to the application which is a running instruction target.
